(19) United States
(12) Patent Application Publication
(10) Pub. No.: US 2008/0296907 A1
(43) Pub. Date: Dec. 4, 2008

(54) ELECTRIC VEHICLE WITH REGENERATION

(76) Inventor: Brad Donahue, Tampa, FL (US)

Correspondence Address: LARSON AND LARSON, 11199 69TH STREET NORTH, LARGO, FL, 33773, US

(21) Appl. No.: 12/188,991

(22) Filed: Aug. 8, 2008

Related U.S. Application Data
(62) Division of application No. 11/143,251, filed on Jun. 2, 2005.

(51) Int. Cl. H02K 7/18

(52) U.S. Cl. 290/1 A; 290/44; 290/40 C

(57) ABSTRACT

An electric powered vehicle has a rechargeable power source coupled to at least one electric motor through a controller. The motor(s) are coupled to a drive train for converting the rotational movement of the motor(s) into linear motion of the vehicle. At least one generator is coupled to the motor(s) for generating a first electric potential for recharging the power source. On the front surface of the vehicle is an air passage that channels air movement to a fan when moving in a forward motion. The fan rotates in response to the air movement and is coupled to a fan generator that turns in response, generating a second electric potential for recharging the power source. The tips of the fan blades are equipped with magnetic material and a series of electro-magnets are configured in proximity of the blades so they can be sequentially energized in absence of air movement to rotate the fan and generating the second electric potential in absence of air movement. The motor(s) and generators will function as a braking system to slow the vehicle when needed and generate electric potentials for charging the power source.

### PRIOR APPLICATIONS

This application is a divisional of U.S. application Ser. No. 11/143,251, filed on Jun. 2, 2005.

### BACKGROUND OF THE INVENTION

1. Field of the Invention

This invention relates to the field of electric powered vehicles and more particularly to a system for powering electric vehicles with power generation for recharging a battery.

2. Description of the Prior Art

For a long while, it has been a challenge to efficiently transport people and goods. Early transportation utilized animals, wind power or human energy to leverage wheels, gears, sails, pedals and the like to move a vehicle containing people and/or cargo. Later, fossil fuels or natural resources were burned to create steam which could be used to power a vehicle such as burning wood or coal in a steam driven locomotive. The combustion engine was invented, using fossil fuel to directly push a piston, creating energy of motion to move a vehicle. For some rare cases, nuclear energy has been used to power a vehicle. In all, modern modes of powering a vehicle require fossil fuel that is becoming move expensive will at some date deplete.

On the other hand, electricity is now a viable power source for vehicles. Electricity can be created in many ways other than using fossil fuel. It can be generated by capturing wind energy in windmills or the energy of falling water in hydroelectric plants or the energy of the tides. It can also be generated directly from solar energy using solar cells. Alternately, it can be generated using nuclear energy which is believed to be in sufficient supply as to last longer than fossil fuels.

Unfortunately, by the nature of vehicles, it is difficult to efficiently power a moving device directly with this generated electricity unless a power delivery infrastructure is in place. In some examples such as electric trains, subways and busses, electricity has been used to power vehicles, but power must be continuously provided to these vehicles by overhead lines or a “third rail”—an infrastructure not easily duplicated on suburban streets, highways and rural roads.

An alternative would be to power the vehicle by an alternative source of electricity that can be transported with the vehicle, such as a battery. Battery powered vehicles have been used successfully in many applications, especially where speed and distance are not a requirement. For example, golf carts are usually powered by a battery. They only need go a few miles per hour and only travel the distance of 18 holes before they can be connected to a power source for recharging.

Various limitations in battery technology have limited their use as a primary source of energy in many vehicles such as cars, boats and planes. For one, the volumetric efficiency and mass efficiency of battery technology has matured slowly, requiring large, heavy battery systems to provide minimal range, acceleration and top speed. Another issue is the lack of availability of ubiquitous power sources and unfriendly recharge timing. There are no “recharge stations” analogous to “gas stations.” Even if there were, it usually takes much longer, perhaps hours, to recharge a battery, making it impractical to stop and recharge on the way to work. Improvements have been made to battery technology, motor technology and vehicle construction to make a battery driven vehicle feasible and useful. Furthermore, electric/combustion hybrid vehicles have been introduced to overcome some of the limitations stated above, but it will take time to develop an infrastructure and either make these vehicles meet the expectation of today's consumers (e.g., drivers) or to transform expectations of today's consumers to adapt to the vehicle's capabilities.

What is needed is a system that will increase the range, acceleration and/or top-speed of an electric powered vehicle.

### SUMMARY OF THE INVENTION

In one embodiment, a system for powering a vehicle is disclosed including a vehicle adapted to transport at least one person, a rechargeable power source within the vehicle and at least one electric motor rotating upon receipt of electricity from the rechargeable power source and coupled to a drive system to move the vehicle in a generally forward or backward motion. A generator is coupled to each of the electric motors for generating electricity to recharge the rechargeable power source. There is also an air passage on a front surface of the vehicle for capturing air movement as the vehicle moves forward and a fan with plurality of fan blades that turn in response to the air movement, converting the air movement into rotational force while the vehicle moves in a generally forward motion. The fan blades have a permanent magnet affixed on each tip and a fan generator is coupled to the fan so the fan generator turns in response to the fan turning, producing electricity to recharge the rechargeable power source. Further included is a plurality of electro magnets, each configured to attract the permanent magnet in sequence, turning the fan in the absence of air movement.

In another embodiment, a method of powering a vehicle is disclosed including providing at least one electric motor coupled to a drive system of a vehicle and a rechargeable power source for powering the electric motors through a controller control. Power from the electric motors is fed to a first set of generators, thereby generating a first electric potential. A fan is coupled to an air passage located in the front of the vehicle so air pressure resulting from a forward movement of the vehicle causes the fan to turn, feeding a rotational energy of the fan to a fan generator, thereby generating a second electric potential. The rechargeable power source is recharged from the first electric potential and the second electric potential.

In another embodiment, an apparatus for powering a vehicle is disclosed including a rechargeable power source connected to a motor to convert the rechargeable power into rotational power. A drive train is connected to the motor to convert the rotational power into linear motion. In addition, a generator is connected to the motor to generate a first electric potential. Also included is an air passage for capturing air from a front end of the vehicle and a fan device adapted to convert air movement from the air passage into rotational movement and a second generator connected to the fan device to generate a second electric potential. The first electric potential and the second electric potential are used to recharge the rechargeable power source.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a top schematic view of a system of a first embodiment of the present invention.

FIG. 2 illustrates a side schematic view of the first embodiment of the present invention.

FIG. 3 illustrates a top schematic view of a second embodiment of the present invention.

FIG. 4 illustrates a side schematic view of the second embodiment of the present invention.

FIG. 5 illustrates a top schematic view of a third embodiment of the present invention.

FIG. 6 illustrates a side schematic view of the third embodiment of the present invention.

FIG. 7 illustrates a side schematic view of a fourth embodiment of the present invention.

FIG. 8 illustrates an expanded schematic view of the fourth embodiment of the present invention.

FIG. 9 illustrates a side schematic view of a fifth embodiment of the present invention.

FIG. 10 illustrates a top schematic view of a sixth embodiment of the present invention.

FIG. 11 illustrates a top schematic view of a seventh embodiment of the present invention.

### DETAILED DESCRIPTION OF THE INVENTION

Reference will now be made in detail to the presently preferred embodiments of the invention, examples of which are illustrated in the accompanying drawings. Throughout the following detailed description, the same reference numerals refer to the same elements in all figures.

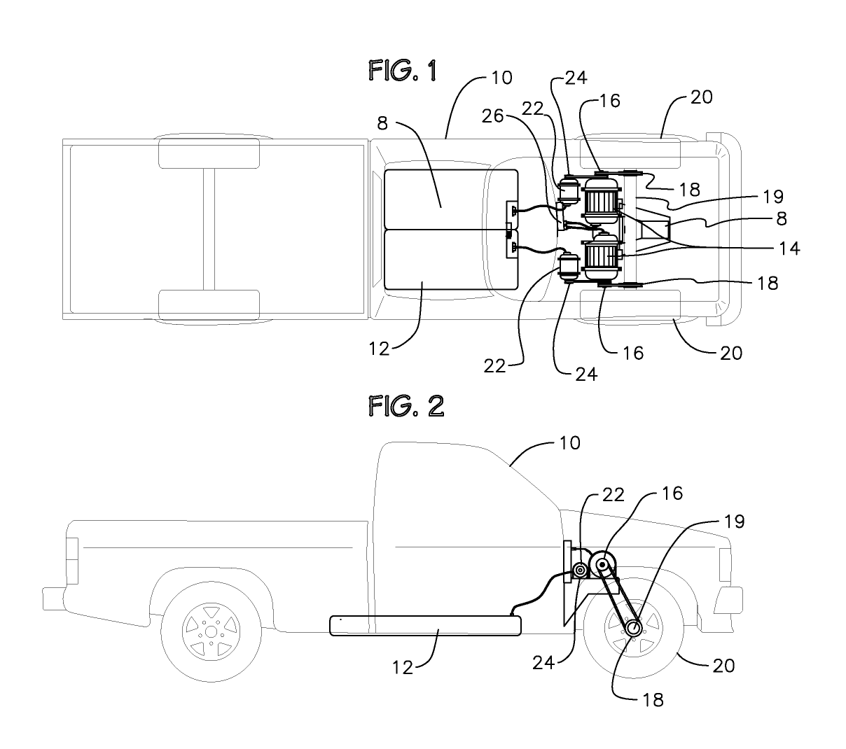

Referring to FIG. 1 and FIG. 2, a top schematic view and a side schematic view of a system of a first embodiment of the present invention is described. A vehicle 10 has a rechargeable power source 12 that powers two motors 14 through a controller 26. The controller 26 is linked to a gas petal or other control mechanism and adjusts the speed of the vehicle 10 by controlling current flow to the motors 14. Each motor 14 has a dual pulley 16 for linking each motor 14 to both a drive pulley 18 and a generator pulley 24. In this embodiment a belt transfers rotational energy from each motor 14 to the drive pulley 18 and to the generator pulley 24, which, in turn, transfers rotational energy to the drive axle 19 and the generators 22, respectively. The axle is coupled to one or both drive wheels 20 and transfers rotational energy to the drive wheels 20 to cause the vehicle to move in a forward or backward linear direction. In some embodiments, the motors 14 are coupled to the drive train through a transmission 8 for providing slippage and various gear ratios. In some embodiments, the motors 14 are directly coupled to the transmission 8 or they are coupled through a gear or chain and sprockets.

As power is applied to the motors 14, the motor's 14 armatures turn and a belt between the motor pulleys 16 and the generator pulleys 24 cause the generators 22 to turn, thereby creating electricity which is fed back to the rechargeable power source 12 where it is conditioned and used to recharge the power source 12. Additionally, when power is not applied to the motors 14 and the vehicle is in motion (e.g., the vehicle is coasting or slowing down), the drive wheels transfer rotational energy back to the motors 14, which then rotates, also causing the generators 22 to rotate. The rotation of the motors 14 and the generators 22 provide additional power which is fed back to the rechargeable power source 12 where it is conditioned and used to recharge the power source 12. In this, the motors 14 act as additional generators. Using the motors and generators of the vehicle to reduce the speed of the vehicle, hence braking the vehicle and reducing the vehicle's kinetic energy is sometimes referred to as “regenerative braking.”

The rechargeable power source 12 is one commonly used in the industry such as lead-acid batteries, lithium-ion batteries, nickel metal hydride batteries, nickel-cadmium batteries. In some embodiments, the batteries create a voltage potential from 12V to 360V. The power is first conditioned so that it can recharge the specific power source 12 by providing the proper charge voltage and current while monitoring the charge cycle so as to not overcharge the power source 12. It is known in the industry how to charge batteries

In some embodiments various motor 14 and generator 22 sizes are used. For example, a first motor 14 is larger than a second motor 14. Both motors 14 are used when accelerating and only the second motor 14 is used when maintaining a speed. In one embodiment, the first motor is 75 HP and the second motor is 25 HP. Likewise, various generator 22 sizes produce different voltage and current levels. In some embodiments, the motor pulley 16 is greater in diameter than the generator pulley 24 by a ratio so that the generator 22 turns faster than the motor 14. For example, if the diameter of the motor pulley 16 is 10 inches and the diameter of the generator pulley 24 is 2 inches, then the ratio is 10:2 or 5:1 and the generator 22 will rotate five times for every rotation of the motor 14. This will create a higher than average voltage potential.

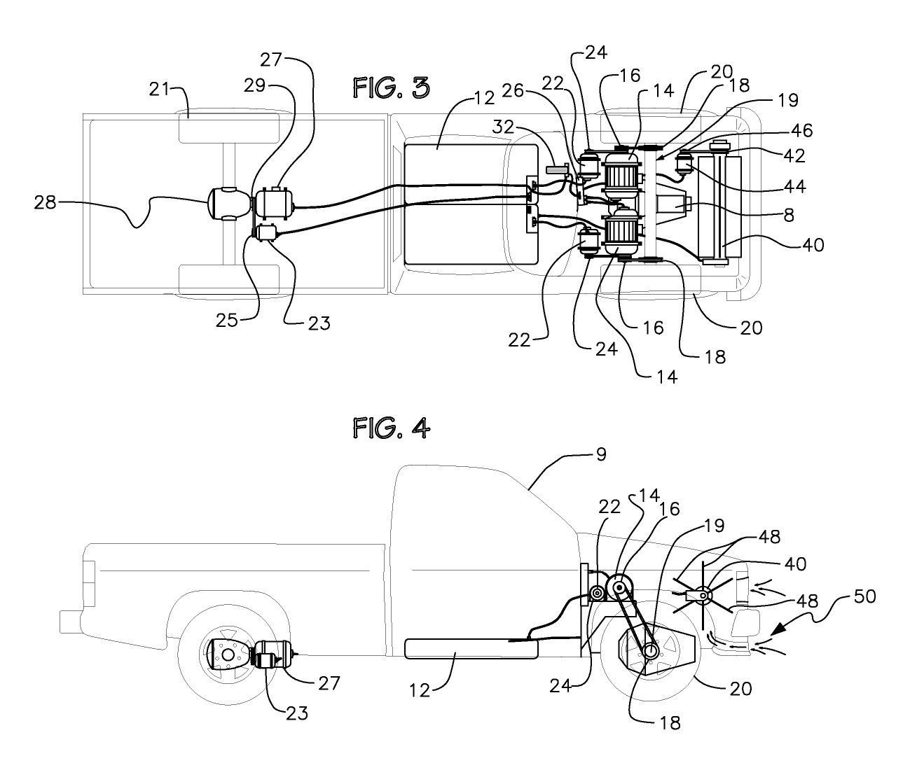

Referring to FIG. 3 and FIG. 4, a top schematic view and a side schematic view of a system of a second embodiment of the present invention is described. A vehicle 9 has a rechargeable power source 12 that powers three motors 14/27 through a controller 26. The controller 26 is linked to a gas petal 32 or other control mechanism and adjusts the speed of the vehicle 9 by controlling current flow to the motors 14/27. Each of the first two motors 14 have a dual pulley 16 for linking each motor 14 to both a drive pulley 18 and a generator pulley 24. In this embodiment a belt transfers rotational energy from each motor 14 to the drive pulley 18 and to the generator pulley 24, which, in turn, transfers rotational energy to the drive axle 19 and the generators 22, respectively. The axle is coupled to one or both drive wheels 20 and transfers rotational energy to the drive wheels 20 to cause the vehicle to move in a forward or backward linear direction. In some embodiments, the motors are coupled to the drive train through a transmission 8 for providing slippage and various gear ratios. In some embodiments, the motors 14 are directly coupled to the transmission 8 or it is coupled through a gear or chain and sprockets. The rear motor 27 is directly coupled to a differential 28, which transfers rotational energy to the rear wheels 21, causing the vehicle to move in a generally forward or backward motion. The rear motor 27 has a pulley 29 that is coupled to a pulley 25 on a third generator 23 by a belt.

When power is applied to the motors 14, the motor's 14 armatures turn, a belt between the motor pulleys 16 and the generator pulleys 24 cause the first two generators 22 to turn and a belt between the rear motor pulley 29 and the rear generator pulley 25 causes the rear generator 23 to turn, thereby creating electricity which is conditioned and used to recharge the power source 12. Additionally, when power is not applied to the motors 14 or to the motor 27 and the vehicle is in motion (e.g., the vehicle is coasting or slowing down), the drive wheels 20/21 transfer rotational energy back to the motors 14/27, which then rotates, also causing the generators 22/23 to rotate. The rotation of the motors 14/27 and the generators 22/23 provide additional power which is fed back to the rechargeable power source 12 where it is conditioned and used to recharge the power source 12.

The rechargeable power source 12 is one commonly used in the industry such as lead-acid batteries, lithium-ion batteries, nickel metal hydride batteries, nickel-cadmium batteries. The power is first conditioned so that it can recharge the specific power source 12 by providing the proper charge voltage and current while monitoring the charge cycle so as to not overcharge the power source 12. It is known in the industry how to charge batteries.

Also shown in this embodiment and referring to FIG. 3 and FIG. 4 is a forward mounted fan 40 that is connected to a fan generator 44 through a fan pulley 42 and a fan generator pulley 46 connected by a belt. As the vehicle travels in a forward direction, air travels in through air passages 50 and blows against the blades 48 of the fan 40, causing the fan to rotate. The rotational energy of the fan 40 is transferred through the fan pulley 42 to the fan generator pulley 46 by the fan belt, causing the fan generator 44 to turn, thereby generating electricity that is used with the electricity generated by the other generators to charge the rechargeable power source 12.

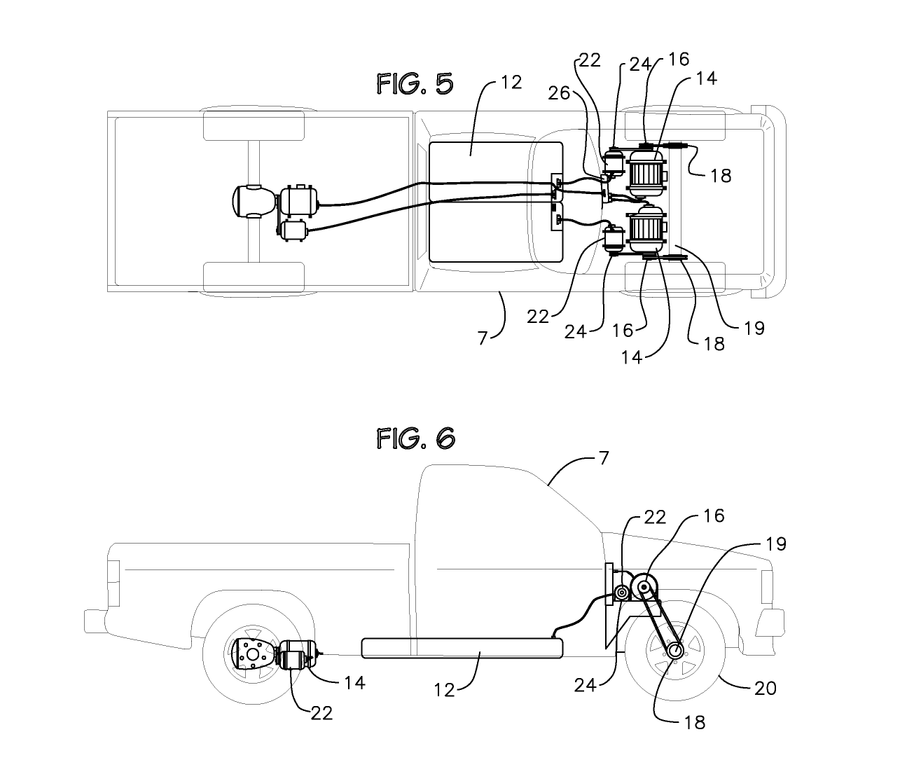

Referring to FIG. 5 and FIG. 6, a top schematic view and a side schematic view of a system of a second embodiment of the present invention is described. A vehicle 7 has a rechargeable power source 12 that powers three motors 14/27 through a controller 26. The controller 26 is linked to a gas petal or other control mechanism and adjusts the speed of the vehicle 7 by controlling current flow to the motors 14/27. Each of the first two motor 14 has a dual pulley 16 for linking each motor 14 to both a drive pulley 18 and a generator pulley 24. In this embodiment a belt transfers rotational energy from each motor 14 to the drive pulley 18 and to the generator pulley 24, which, in turn, transfers rotational energy to the drive axle 19 and the generators 22, respectively. The axle is coupled to one or both drive wheels 20 and transfers rotational energy to the drive wheels 20 to cause the vehicle to move in a forward or backward direction. In some embodiments, the motors 14 are coupled to the drive train through a transmission 8 for providing slippage and various gear ratios. In some embodiments, the motors 14 are directly coupled to the transmission 8 or it is coupled through a gear or chain and sprockets. The rear motor 27 is directly coupled to a differential 28, which transfers rotational energy to the rear wheels 21, causing the vehicle to move in a generally forward or backward motion. The ear motor 27 has a pulley 29 that is coupled to a pulley 25 on a rear generator 23 by a belt.

When power is applied to the motors 14, the motor's 14 armatures turn, a belt between the motor pulleys 16 and the generator pulleys 24 cause the first two generators 22 to turn and a belt between the rear motor pulley 29 and the rear generator pulley 25 causes the rear generator 23 to turn, thereby creating electricity which is conditioned and used to recharge the power source 12. Additionally, when power is not applied to the motors 14/27 and the vehicle is in motion (e.g., the vehicle is coasting or slowing down), the drive wheels transfer rotational energy back to the motors 14/27, which then rotates, also causing the generators 22/23 to rotate. The rotation of the motors 14/27 and the generators 22/23 provide additional power which is fed back to the rechargeable power source 12 where it is conditioned and used to recharge the power source 12.

The rechargeable power source 12 is one commonly used in the industry such as lead-acid batteries, lithium-ion batteries, nickel metal hydride batteries, nickel-cadmium batteries. The power is first conditioned so that it can recharge the specific power source 12 by providing the proper charge voltage and current while monitoring the charge cycle so as to not overcharge the power source 12. It is known in the industry how to charge batteries.

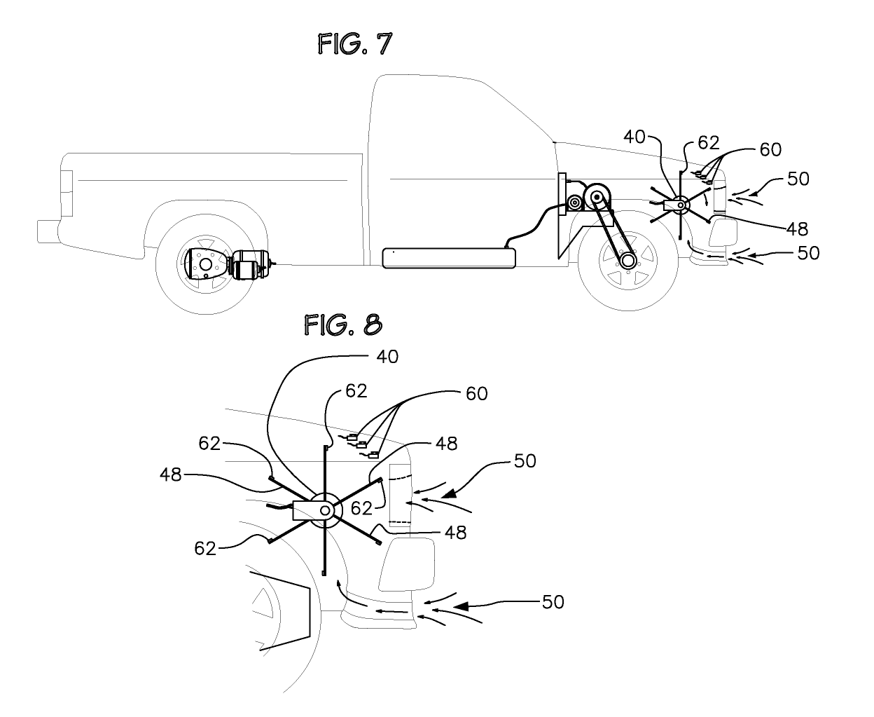

Referring to FIG. 7 and FIG. 8, a side schematic view and an expanded view of a fourth embodiment of the present invention is shown. In this embodiment a forward mounted fan 40 is connected to a fan generator 44 as shown in FIG. 3 and FIG. 4. When the vehicle is stationary, no air travels in through an air passage 50 and the blades 48 of the fan 40 do not turn. In this embodiment, each fan blade 48 has a magnet material 62 affixed on an outer edge or tip and there is a plurality of electro-magnets 60 arranged in a sequential fashion so that when the vehicle is not moving, the electro-magnets 60 can be sequentially energized, much like an electric motor, causing the fan 40 to turn. The magnetic material is steel or iron or it is a permanent magnet made from iron or powdered iron. The magnetic material may be coated to reduce or prevent rust. Since the fan 40 is linked to the fan generator 44, the fan generator 44 will turn, thereby generating electricity that is used with the electricity generated by the other generators 22 to charge the rechargeable power source 12.

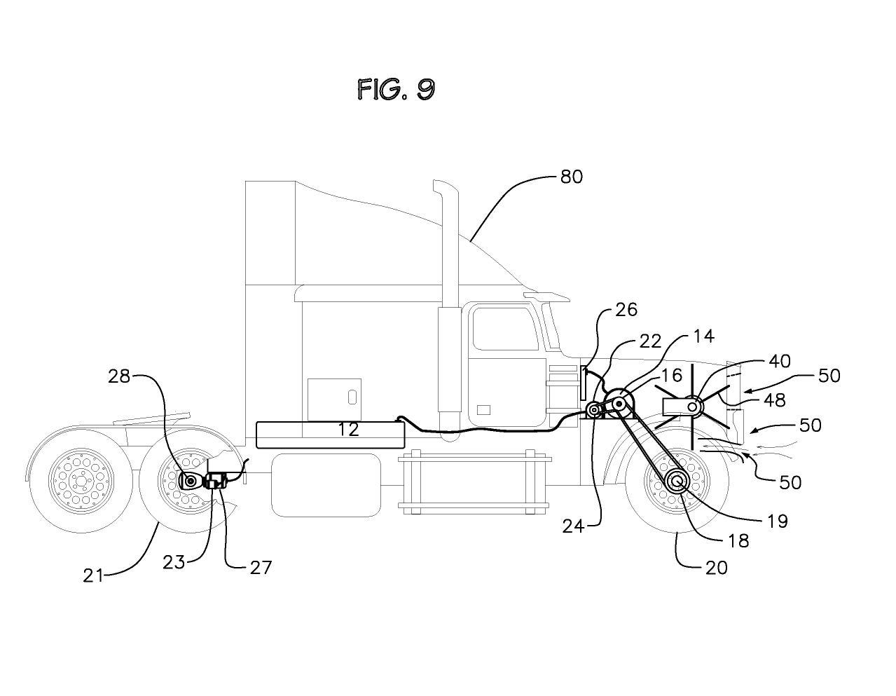

Referring to FIG. 9, a side schematic view of a fifth embodiment of the present invention is described. A truck 80 has a rechargeable power source 12 that powers three motors 14/27 through a controller 26. The controller 26 is linked to a gas petal or other control mechanism and adjusts the speed of the truck 80 by controlling current flow to the motors 14/27. Each of the first two motor 14 has a dual pulley 16 for linking each motor 14 to both a drive pulley 18 and a generator pulley 24. In this embodiment a belt transfers rotational energy from each motor to the drive pulley 18 and to the generator pulley 24, which, in turn, transfers rotational energy to the drive axle 19 and the generators 22, respectively. The axle is coupled to one or both drive wheels 20 and transfers rotational energy to the drive wheels 20 to cause the vehicle to move in a forward or backward direction. In some embodiments, the motors 14 are coupled to the drive train through a transmission 8 for providing slippage and various gear ratios. In some embodiments, the motors 14 are directly coupled to the transmission 8 or they are coupled through a gear or chain and sprockets. The third motor 27 is directly coupled to a differential 28, which transfers rotational energy to the rear wheels 21, causing the truck to move in a generally forward or backward motion. The third motor is coupled to a third generator 23.

When power is applied to the motors 14/27, the motor's 14/27 armatures turn, a belt between the motor pulleys 16 and the generator pulleys 24 cause the first two generators 22 to turn and a belt between the rear motor pulley 29 and the rear generator pulley 25 causes the rear generator 23 to turn, thereby creating electricity which is conditioned and used to recharge the power source 12. Additionally, when power is not applied to the motors 14/27 and the vehicle is in motion (e.g., the vehicle is coasting or slowing down), the drive wheels 20/21 transfer rotational energy back to the motors 14/27, which then rotate, also causing the generators 22/23 to rotate. The rotation of the motors 14/27 and the generators 22/23 provide additional power which is fed back to the rechargeable power source 12 where it is conditioned and used to recharge the power source 12.

The rechargeable power source 12 is one commonly used in the industry such as lead-acid batteries, lithium-ion batteries, nickel metal hydride batteries, nickel-cadmium batteries. The power is first conditioned so that it can recharge the specific power source 12 by providing the proper charge voltage and current while monitoring the charge cycle so as to not overcharge the power source 12. It is known in the industry how to charge batteries.

Also shown in this embodiment is a forward mounted fan 40 that is connected to a fourth generator. As the vehicle travels in a forward direction, air travels in through an air passage 50 and blows against the blades 48 of the fan 40, causing the fan 40 to rotate. The rotational energy of the fan 40 is transferred to the fan generator 44, causing the fan generator to turn, thereby generating electricity that is used with the electricity generated by the other generators to charge the rechargeable power source 12.

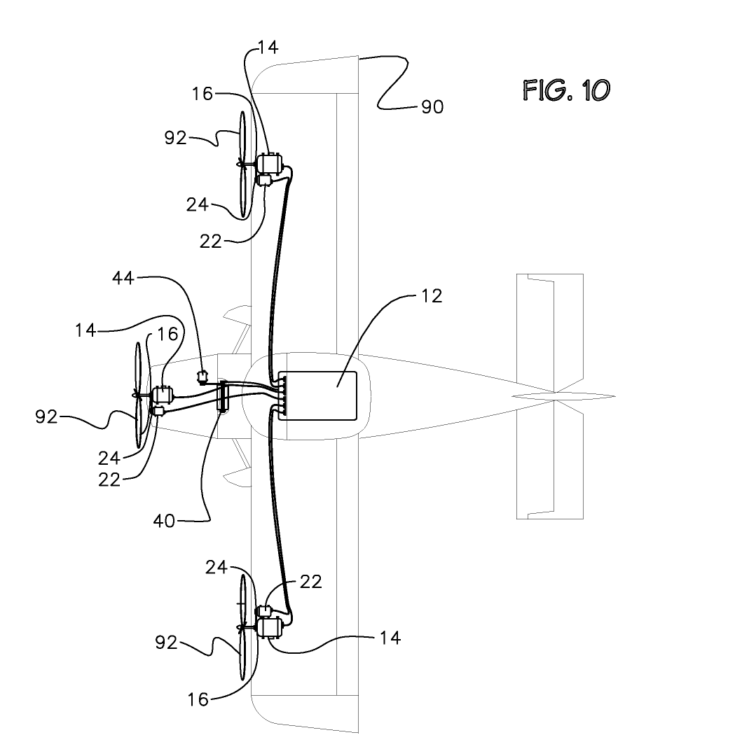

Referring to FIG. 10, a top schematic view of a sixth embodiment of the present invention is described. An airplane 90 has a rechargeable power source 12 that powers three motors 14 through a controller. The controller is linked to a gas petal or other control mechanism and adjusts the speed of the airplane 90 by controlling current flow to the motors 14. Each of the motors 14 directly drive a propeller 92 for causing the airplane to go in a forward direction. Each of the motors 14 also have a pulley 16 for linking to a generator pulley 24. In this embodiment a belt transfers rotational energy from each motor pulley 16 to the generator pulley 24, which, in turn, transfers rotational energy to the generators 22. As the motor's 14 armatures turn, a belt between the motor pulley 16 and the generator pulley 24 causes the three generators 22 to turn, thereby creating electricity which is conditioned and used to recharge the power source 12. The rechargeable power source 12 is one commonly used in the industry such as lead-acid batteries, lithium-ion batteries, nickel metal hydride batteries, nickel-cadmium batteries. The power is first conditioned so that it can recharge the specific power source 12 by providing the proper charge voltage and current while monitoring the charge cycle so as to not overcharge the power source 12. It is known in the industry how to charge batteries.

Also shown in this embodiment is a forward mounted fan 40 that is connected to a fourth generator 44. As the airplane travels in a forward direction, air travels in through an air passage and blows against the blades of the fan 40, causing the fan to rotate. The rotational energy of the fan 40 is transferred to the fan generator 44, causing the fan generator to turn, thereby generating electricity that is used along with the electricity generated by the other three generators to charge the rechargeable power source 12.

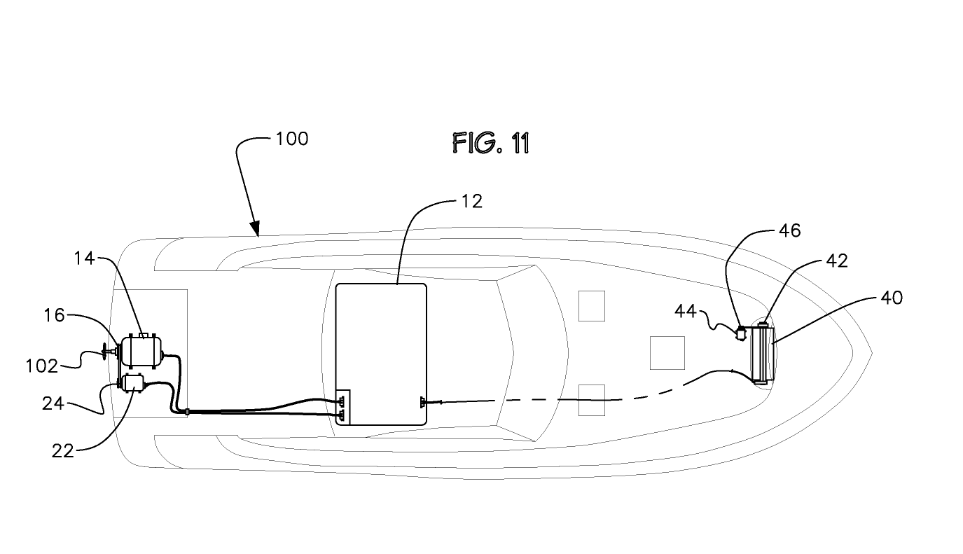

Referring to FIG. 11, a top schematic view of a seventh embodiment of the present invention is described. A boat 100 has a rechargeable power source 12 that powers a motor 14 through a controller. The controller is linked to a gas petal or other control mechanism and adjusts the speed of the boat 100 by controlling current flow to the motor 14. The motor 14 directly drives a propeller 102 for causing the boat to go in a forward or backward direction. The motor 14 also has a motor pulley 16 for linking to a generator pulley 24. In this embodiment a belt transfers rotational energy from the motor pulley 16 to the generator pulley 24, which, in turn, transfers rotational energy to the generator 22. As the motor's 14 armatures turns, a belt between the motor pulley 16 and the generator pulley 24 causes the generator 22 to turn, thereby creating electricity which is conditioned and used to recharge the power source 12. The rechargeable power source 12 is one commonly used in the industry such as lead-acid batteries, lithium-ion batteries, nickel metal hydride batteries, nickel-cadmium batteries. The power is first conditioned so that it can recharge the specific power source 12 by providing the proper charge voltage and current while monitoring the charge cycle so as to not overcharge the power source 12. It is known in the industry how to charge batteries.

Also shown in this embodiment is a forward mounted fan 40 that is connected to a fan generator 44. As the boat travels in a forward direction, air travels in through an air passage and blows against the blades of the fan 40, causing the fan 40 to rotate. The rotational energy of the fan 40 is transferred to the fan generator 44 through a fan pulley 42 and a fan generator pulley 46, causing the fan generator 44 to turn, thereby generating electricity that is used with the electricity generated by the other generator to charge the rechargeable power source 12.

Equivalent elements can be substituted for the ones set forth above such that they perform in substantially the same manner in substantially the same way for achieving substantially the same result. Although the disclosed embodiments show examples of up to three motors and up to four generators, there is no limitation within the present invention that limits the vehicle to any specific number of motors or generators as long as there is at least one motor and at least one generator. Furthermore, it is anticipated that in some embodiments, some motors will have associated generators and some motors will not include an associated generator. In some embodiments, the air vent and fan/fan generator will not be included.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A system for powering a vehicle, the system comprising:
a vehicle adapted to transport at least one person;
a rechargeable power source disposed within the vehicle;
at least one electric motor configured to rotate upon receipt of power from the rechargeable power source, the at least one electric motor coupled to a drive system of the vehicle to move the vehicle in a generally forward or backward motion;
for each one of the at least one electric motor, a generator coupled to the one of the at least one electric motor so the generator turns when the one of the at least one electric motor turns, thereby generating a first electric potential for recharging the rechargeable power source;
an air passage on a front surface of the vehicle for capturing air movement as the vehicle moves in a generally forward motion;
a fan configured to accept the air movement, the fan having a plurality of fan blades adapted to convert the air movement into rotational force while the vehicle moves in the generally forward motion, a magnetic material affixed thereon a tip of each of said plurality of fan blades;
a fan generator coupled to the fan so turning of the fan causes the fan generator to turn, the fan generator producing a second electric potential for recharging the rechargeable power source; and
a plurality of electro magnets, each of said plurality of electro magnets configured to attract the magnetic material in sequence, thereby turning the fan in an absence of the air movement.

2. The system for powering a vehicle of claim 1, wherein the rechargeable power source is a rechargeable battery.

3. The system for powering a vehicle of claim 1, wherein the vehicle is selected from the group consisting of an automobile, an airplane, a truck, a bus, a recreational vehicle and a boat.

4. The system for powering a vehicle of claim 1, wherein the drive system comprises two wheels connected to an axle.

5. The system for powering a vehicle of claim 4, whereas the at least one motor is coupled to the drive system through a transmission and when the vehicle is in motion and power from the rechargeable power source is not applied to the at least one electric motor, the first electric potential for recharging the rechargeable power source is produced by the at least one generator and a third electric potential for recharging the rechargeable power source is produced by the at least one electric motor.

6. The system for powering a vehicle of claim 1, wherein the one of the at least one motor is coupled to the drive system through a differential.

7. The system for powering a vehicle of claim 1, wherein the drive system is at least one propeller blade.
